(19) United States
(12) Patent Application Publication
(10) Pub. No.: US 2003/0014999 A1
(43) Pub. Date: Jan. 23, 2003

(54) Method for producing fine glass articles and the use of said method

(76) Inventors: Steffen Koerner, Delligsen (DE); Wolfgang Semar, Mainz (DE); Ralf Bonitz, Mainz (DE); Christian Schenk, Ingleheim (DE)

Correspondence Address: Striker Striker & Stenby, 103 East Neck Road, Huntington, NY, 11743, US

(21) Appl. No.: 10/220,255

(22) PCT Filed: Apr. 26, 2001
(86) PCT No.: PCT/EP01/04708

(51) Int. Cl. C03B 11/00

(52) U.S. Cl. 65/127

(57) ABSTRACT

A method for producing thin glass articles from low-viscosity glass, in particular of glass with viscositiesⁿ<10 dPas is presented, in which a thin-bodied glass composition is fed into a lower tool (1), and the glass composition is compressed by driving an upper tool (4), positioned opposite the lower tool (1), and the lower tool (1) together. The invention also relates to the use of the method. A method for producing thin glass articles is to be furnished, in which the problem of rapid cooling that occurs in the prior art is eliminated, so as to enhance the quality of the finished glass and to create the possibility of producing thin glass articles by means of pressing. The method according to the invention provides a remedy in that the surface roughness (R_{z}) of the tools (1, 4) is between 5 and 15 μm, and between the method step of “feeding” and the method step of “compressing” is preformed by forces of acceleration, accelerations between 1 and 10 G (acceleration due to gravity) being realized.

The invention relates to a method for producing thin glass articles, in particular substrates, in particular hard disk substrates, spherical and aspherical lens arrays, and micro- and macrostructured bodies made of low-viscosity glass, in particular of glass with viscosities ₙ<10 dpas, in which a thin-bodied glass composition is fed into a lower tool, and the glass composition is compressed by driving an upper tool, positioned opposite the lower tool, and the lower tool together.

The invention also relates to the use of the method. This method serves, among other things, to produce diffractive refractive lenses, where “lenses” in terms of the invention is meant to include reflecting optical elements as well. Spherical and aspherical lens arrays are in practice known as integrator plates.

Because of their upper devitrification temperature and what is as a rule a high rate of crystal growth, many glass melts for optical and technical applications must be processed at very high temperatures and thus very low viscosities. This demands a method which draws as little heat as possible from the glass melt between the feeding and forming, so that at the instant of forming, as hot as possible a glass melt is still present, in other words one with low viscosity that is easily deformed. To achieve the requisite rapid processing for this purpose, after the glass melt has been introduced and positioned by the feeder, it must be delivered to hot forming with the least possible time lag.

Pressing glass articles is one of the most versatile and most widespread production methods in glass processing. There is practically no weight limit for the glass gobs to be processed by the fully automatic machine presses. Articles that weigh only a few grams as well as those weighing several kilograms are processed by machine. The machines used for production are correspondingly versatile. Besides manually operated or semiautomatic presses, which as a rule operate as multi-station rotary-table presses with a die and multiple molds.

A common feature of automated pressing methods is the spatial separation of the various process steps, such as feeding, pressing, and removal. Superimposed on the entire process is the fact that cooling of the glass gob progresses over time until the final solidification.

In thin waferlike semifinished glass products, such as substrates, lens arrays, aspherical arrays and structured bodies, stringent demands are made in terms of surface quality, and in particular the surface roughness.

To that end, in the prior art, systems are used that have both a feeder and a pressing tool, which generally comprises one upper tool and a plurality of lower tools.

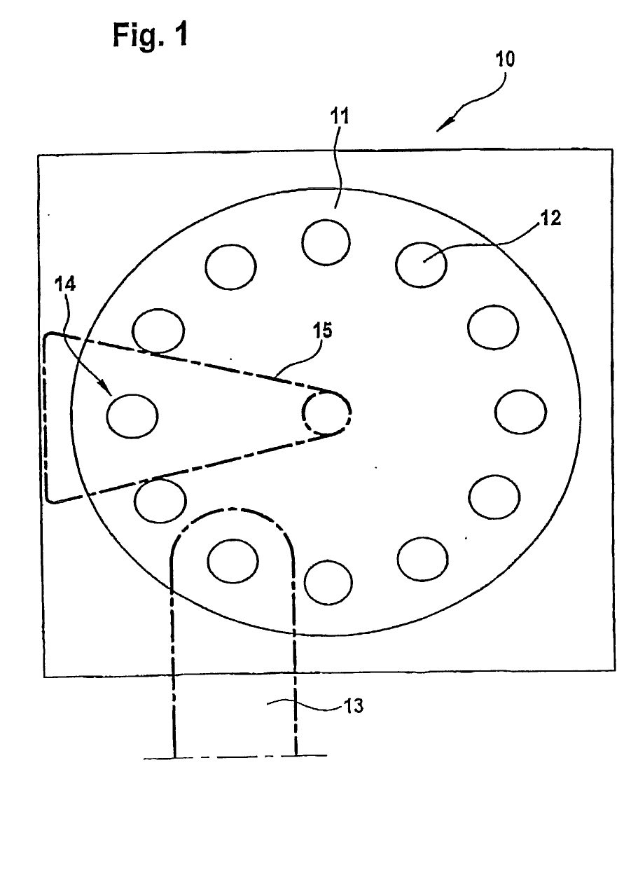

FIG. 1 schematically shows a round-table press (10) from above, that is, looking in the direction of the field of gravity. In these traditional round-table presses, the apportioned glass gobs are introduced directly beneath the feeder (13) into lower tools (12) or pressing molds disposed on the press table (11). By rotation of the press table, the lower tool is then moved in common with the glass gob positioned on it into the pressing station (14), or in other words is moved underneath the upper tool (15) or pressing die.

In this rotary motion of the press table, the glass gob is exposed in the pressing mold or lower tool to tangential forces of acceleration and radial centrifugal forces. The quantity of these horizontal forces is dependent on the geometrical dimensions of the press table, the spacing of the lower tool or pressing mold and of the glass composition, disposed thereon, from the center of rotation, and the speed of the rotary motion and the mass of the introduced glass melt itself.

Upon a rapid notion of the press table and the low-viscosity glass melts in question here, with viscosities <10 dpas, this can cause a motion or a marked asymmetrical deformation of the fed-in glass gob. In the least favorable case, some of the glass gob slops over the edge of the mold and leaves the mold.

For processing thin-bodied glass melts, only low transport speeds and transport accelerations are therefore tolerable as a rule. This means slow transportation and thus an unfavorably long processing time, and hence an unacceptably long dwell time of the glass melt between the feeding and the pressing operation. The pressing tools, such as the lower tool, upper tool and mold ring, draw heat from the glass gob upon contact, and the heat transfer takes place to the contact faces between the tool and workpiece. The consequence is sometimes considerable cooling of the fed-in glass gob and thus markedly restricted forming. The quality of the glass is markedly lowered as a result. Especially because the peripheral zones of the glass droplet are already cooled, low wall thickness can be expelled only with extreme restriction.

As the glass composition of the glass gob fed in decreases, the cooling of this glass gob is completed in shorter and shorter periods of time, since the heat-emitting surface area does not decrease to the same extent as the heat-storing glass composition itself. Consequently, the problems described gain particular significance especially in the production of thin lenses and substrates.

The pressing tools made from high-strength materials as a rule also have a high thermal capacity and more rapidly draw the heat from a thin glass blank and cool it more quickly, assuming equal-sized contact faces or the same heat transfer. In glass blanks with a thickness of about 0.7 mm, for instance, as a result of the contact with the pressing tools a very fast, continuous cooling is demonstrated, so that before the forming, the cooling has already progressed so far that the final form is no longer attainable.

Counteracting the problem of rapid cooling in the production of thin glass articles by feeding in more glass composition than necessary and then bringing what is then a substantially thicker glass blank to the requisite slight thickness in postmachining, which can include lapping and polishing operations, does not attain the desired goal. Proceeding in this way is highly time consuming and expensive.

On the other hand, fast transporting entails the risk of cracking during the pressing operation, because of creases or striations in the glass gob from deformation during horizontal transportation. The primary goal of fast processing collides, in the conventional methods, with the incident horizontal forces.

Against this background, it is the object of the present invention to furnish a method for producing thin glass articles by pressing thin-bodied, low-viscosity glasses, especially glasses with a viscosity <10 dpas, in which the disadvantages known from the prior art, especially those associated with the rapid cooling of the glass gob, and the attendant low production quality are avoided.

This object is attained by a method of the generic type in question in which the surface roughness R_{z} of the tools is between 5 and 15 μm, and between the method step of “feeding” and the method step of “compressing” is preformed by forces of acceleration, accelerations between 1 and 10 G (acceleration due to gravity) being realized.

This exploits the fact that especially low-viscosity glass gobs can in part be deformed considerably when forces due to acceleration are exerted on them. The temperature and the viscosity of the glass correlate with one another, and therefore highly tempered glass gobs have a lower viscosity than low-tempered glass gobs. Highly tempered and thus low-viscosity glass gobs have a thin-bodied consistency and are therefore more easily deformable, using lesser forces.

Because the deformation under the influence of forces of acceleration is utilized in a targeted way for deforming the glass gob., in the ensuing pressing step both the applied pressure of the forming tools and the contact time between tool and workpiece, that is, the glass and the forming tool, can be reduced.

Especially the upper tool, during the deformation of the glass gob, is not in contact with this glass gob, and therefore the contact area of the glass gob with the lower tool that is responsible for the heat transfer is restricted. Since the quantity of heat dissipated is due to the heat flow and the contact time, the absolute dissipated heat quantity can be reduced by reducing the contact time.

The method of the invention, in which the absolute quantity of heat dissipated from the glass gob to be processed is minimized on the one hand by reducing the contact areas and on the other by reducing the contact time, assures that until the concluding forming process by pressing, the glass gob remains highly tempered and thus of low viscosity and thin-bodied, that is, easily deformable. Because of the easy deformability, it is furthermore possible, at the same pressure of the forming tools, to reduce the axial thickness of the compressed glass blank in comparison with conventional methods.

It has furthermore been found that the glass articles produced by the method of the invention have a higher surface quality than conventionally produced glass articles, and in particular, as already noted, very thin glass articles can be produced. Precisely the production of thin glass articles by pressing methods was considered in the prior art to be unfeasible, for the reasons described at the outset.

Post-machining of the pressed glass blank is now necessary only to a slight extent, since with the aid of the forming process of the invention very slight axial thicknesses can already be achieved.

Good results are attained in glass gobs that have a dynamic viscosity ⁿ<10 dpas, preferably ⁿ<4 dPas.

The accelerations required for a deformation of the glass gob are quantitatively between the acceleration G due to gravity and ten times the acceleration G due to gravity. The higher the acceleration of the glass gob, the greater is the deformation of the glass gob attained by the forces of acceleration. What acts on the glass gob fed into the lower tool is essentially its own weight F_{G}, as well as the force F_{W} acting on it from the lower tool and the force of inertia F_{T} brought about as a consequence of the acceleration or deceleration of the glass gob by motion of the lower tool. While the weight is a variable that does not change over time, the latter two forces F_{W} and F_{T} are dynamic forces, that is, forces that are variable over time.

The glass gob can in principle be preformed in various ways by forces of acceleration. If the conventional multi-station rotary-table presses are used, for instance, then when the glass gob is transported from the feeding station to the pressing station, outward-oriented centrifugal forces, as forces of acceleration, engage the glass gob. If these forces of acceleration are combined with a decentralized infeeding of the glass gob into the lower tool, then the fed-in glass gob can be deformed in a targeted way even before the pressing operation, or in other words can be distributed relatively uniformly in the mold.

Another possible way of preforming the glass gob by forces of acceleration is for the mold, formed by the lower tool, to be made to rotate about its own axis after the glass gob has been fed in. As a result of the radial accelerations resulting from the rotation, centrifugal forces act on the glass gob, which pull the glass out of the middle of the mold toward the edge of the mold. The rotary speed and rotation time serve as variables that influence the scope and type of deformation.

Another parameter to be taken into account, which has an influence on the preforming of the glass gob, is the roughness R_{Z} of the tool surfaces, and especially the surface of the lower tool. This should be in the range between 5 and 15 μm.

Surprisingly, it has been demonstrated that the glass flows apart better and within the context of the preforming is distributed more easily over the surface of the lower tool if the surface of the lower tool is not ideally smooth but instead has a certain roughness. Experiments have shown that lower tools with a roughness R_{Z} of 9 μm should preferentially be used. Furthermore, a certain roughness of the tool surfaces counteracts adhesion of the glass gob or the pressed glass blank to the tool, so that on the one hand the quality of the glass articles produced and on the other the service life of the tools are increased, because of the prevention of deposits.

The method of the invention for producing thin glass articles has significance especially in the production of aspherical structures, whose post-machining, which as a rule comprises a grinding operation, is especially complex because of the nonuniform radius of curvature. In the prior art, aspherical contours can also be attained by reheating the pressing blank and then forming it. Once again, this is complex and expensive.

In addition to the possibility of producing substrates and diffractive, refractive and reflective optical elements by means of the method, it is also possible to produce both micro- and macrostructured bodies and components by pressing methods; suitably structured fogs are then used. In the prior art, conversely, as a rule structured bodies are produced in two stages, in which a blank, first produced by the pressing method, has to be reheated for the sake of the structuring.

Embodiments of the method in which the glass gob is preformed by an acceleration in the vertical direction are advantageous.

A favorable aspect of this variant method is that the forces engaging the glass gob, the action lines of the weight F_{G}, the inertial force F_{T} and the force F_{W} exerted by the tool on the glass gob, extend parallel to one another.

As a rule, the force F_{W} exerted on the glass gob by the lower tool is quantitatively composed of the sum of the weight F_{G} and the inertial force F_{T}, while F_{W} is oriented counter to the two forces F_{G} and F_{T}. The principle of action equals reaction applies. The glass gob positioned on the lower tool is then compressed upon acceleration or deceleration of the lower tool between the two contrary forces, which both correspond quantitatively to the force F_{W}. As a result, the droplet-shaped glass gob or glass droplet after the infeeding is preformed to a more or less flat disk. A favorable aspect of this preferred embodiment is that the weight of the glass gob represents a portion of the preforming force, and therefore in a sense it contributes a component of an acceleration due to gravity to the acceleration to be generated.

Embodiments of the method in which the glass gob is preformed by a downward-oriented, abruptly decelerated, and acceleration-inducing motion of the lower tool are advantageous.

In this embodiment, the lower tool, which had been positioned below the feeder for the infeeding of the thin-bodied glass composition, is moved downward with the glass gob positioned on it and then abruptly braked. By the braking or deceleration of the lower tool and the glass gob located on it, the inertial force F_{T} is generated, which together with the weight F_{G} presses the glass gob flat.

A favorable aspect of this variant method is that in the majority of applications, at least when horizontal forces or forces of acceleration are to be avoided, the lower tool must be driven into a more deeply located position anyway, so that an interstice can be created between the feeder and the lower tool for the placement of the upper tool that is equally necessary for the forming process. This lowering of the lower tool which is then necessary anyway is simultaneously exploited, in the advantageous embodiment, for preforming the glass gob, and therefore no additional motion that generates an acceleration is required.

Embodiments of the method in which the maximum acceleration is achieved at the end of the lowering process of the lower tool are advantageous.

However, embodiments of the method in which the glass gob is preformed by an upward-oriented, abruptly accelerated, and acceleration-inducing motion of the lower tool are also favorable.

On the one hand, this embodiment can be combined with the embodiment described earlier, so that the glass gob positioned on the lower tool is subjected to a two-stage preforming, in that in a first stage, it is preformed by a lowering of the lower tool, and in a second stage it is preformed by a raising of the lower tool.

Even taken per se, however, there are also applications in which this embodiment is advantageous. For example, if lowering the lower tool for positioning the upper tool is not absolutely necessary, or if for positioning the upper tool the lower tool is not lowered but instead the feeder is removed. If in these cases the lower tool and upper tool must be driven toward one another, then the motion of the lower tool can be utilized for a preforming.

It is equally conceivable for the upper tool to be fixed for the pressing operation while the lower tool is the tool that is moved. In these cases as well, a motion of the lower tool that is necessary anyway is utilized for preforming the glass gob.

In this last embodiment of the method, variants characterized in that the maximum acceleration of the lower tool is generated at the onset of the motion are advantageous.

The background of this preferred embodiment is that the accelerated lower tool must be braked or decelerated again, and the deceleration then to be performed generates inertial forces, which are contrary to pressing the glass gob flat. Consequently, the attempt is made to subject the lower tool at the onset of the motion to the maximum acceleration, then to decrease this acceleration slowly and thereby bring the lower tool to a standstill after a certain distance.

The method in which the glass melt is subjected essentially to only vertical forces between the method steps of “feeding” and the method step of “pressing” is advantageous.

As a result, a decentralized positioning of the glass gob in the lower tool from the action of horizontal forces can be averted.

An asymmetrical deformation of the glass gob as a consequence of nonvertical forces is also averted. Creasing and striations in the glass gob are dispensed with, along with the horizontal transportation that causes them. It becomes impossible for some of the glass gob to escape from the mold. Furthermore, a decoupling of the production or transport speed from the horizontally acting forces that limit this speed is accomplished in a simple way by eliminating the latter forces. The production and transport speed can be freely selected independently, entirely in accordance with the necessity of rapid further processing that is due to the cooling of the glass gob.

Embodiments of the invention are advantageous in which the lower tool, for the feeding operation, is positioned below the feeder outlet, and the thin-bodied glass is fed in; after the termination of the feeding operation the lower tool is lowered vertically, together with the fed-in glass gob, as far as a lower position of repose; and the upper tool, located in a parking position during the feeding operation, is introduced into the interstice formed between the feeder outlet and the lower tool by the lowering of the lower tool, the upper tool being fixed for the pressing operation, and the glass gob is pressed into form by the upward motion of the lower tool in the direction of the thus-fixed upper tool.

Furthermore, embodiments of the invention are also advantageous in which the lower tool, for the feeding operation, is positioned below the feeder outlet, and the thin-bodied glass is fed in; after the termination of the feeding operation the lower tool is lowered vertically, together with the fed-in glass gob, as far as a lower position of repose; and the upper tool, located in a parking position during the feeding operation, is introduced into the interstice formed between the feeder outlet and the lower tool by the lowering of the lower tool, and by downward motion of the upper tool in the direction of the lower tool which is fixed for the pressing operation, the glass gob is pressed into form.

A very favorable method variant provides that the upper tool during the feeding operation is parked laterally and thus at the same height as the interstice embodied between the feeder outlet and the lower tool by the lowering of the lower tool, and for the pressing operation the upper tool is positioned by a lateral, essentially horizontal inward shift or inward pivoting into the interstice above the lower tool.

As a result, in the introduction only a two-dimensional motion of the upper tool into the interstice is necessary. A substantially more-complex three-dimensional motion can thus be avoided. As a consequence, both the mechanics to be furnished for moving the upper tool and the requisite control need to meet only substantially less-stringent demands, and thus costs for the means of production are lowered.

The use of the method of the invention for producing electrically insulating carrier plates for electrical circuits and components, especially substrates for printed circuit boards, and for substrates on which electrical circuits are printed, is also part of the scope of the present invention.

In the prior art, such components are not produced by pressing, because the known pressing methods do not make it possible to produce substrates of slight thickness.

The method also proves to be advantageous in the production of so-called hard disk substrates.

In the prior art, the starting material or blank for the hard disk is pressed glass, and the pressed outside diameter D of the blank is somewhat greater than the requisite diameter of the hard disk blank. To achieve the final blank thickness, lapping and polishing operations then follow. The thickness d of the pressed blank is dependent on the outside diameter D and is for instance 1.1 mm, for an outside diameter D of 99 mm. The ratio between the thickness d and the diameter D is thus d/D=0.0115, or 1.15%.

With the aid of the method of the invention, low-viscosity glasses can be pressed, thus creating the possibility of producing thin substrates by pressing methods. Thus in the production of hard disk substrates as well, blanks of slight thickness for the same outside diameter can be created. As can be seen from the table below, with the aid of the method of the invention the ratio d/D in the above example can be reduced from 1.15% to 0.95%. This is approximately equivalent to a reduction of the ratio by 20%.

| Outside Diameter D | Thickness d | Ratio d/D |
|---|---|---|
| 95 mm | 0.90 mm | 0.95% |
| 84 mm | 0.85 mm | 1.01% |
| 65 mm | 0.80 mm | 1.23% |

Besides the savings of material, above all the shortening of the lapping and polishing operations is advantageous.

The method according to the invention will be described in further detail below schematically in terms of an exemplary embodiment. Shown are:

FIG. 1, schematically, a multi-station rotary-table press from above;

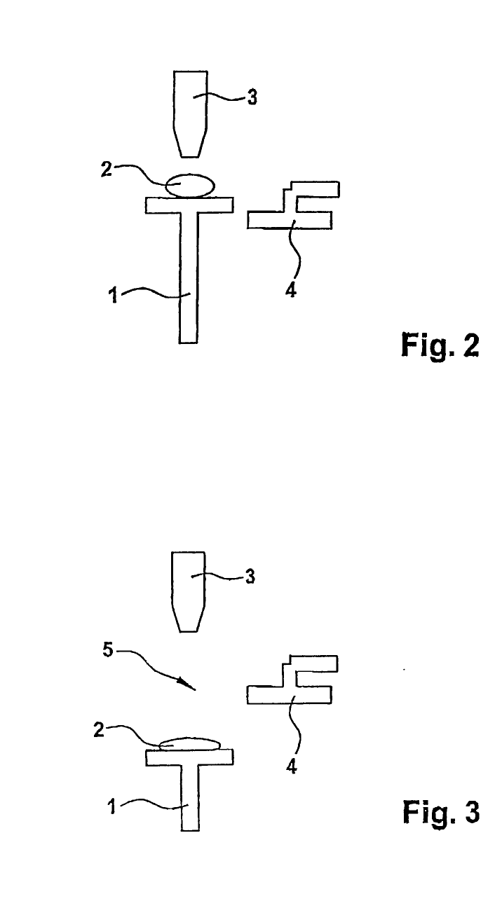

FIG. 2, the operation of feeding in the glass gob;

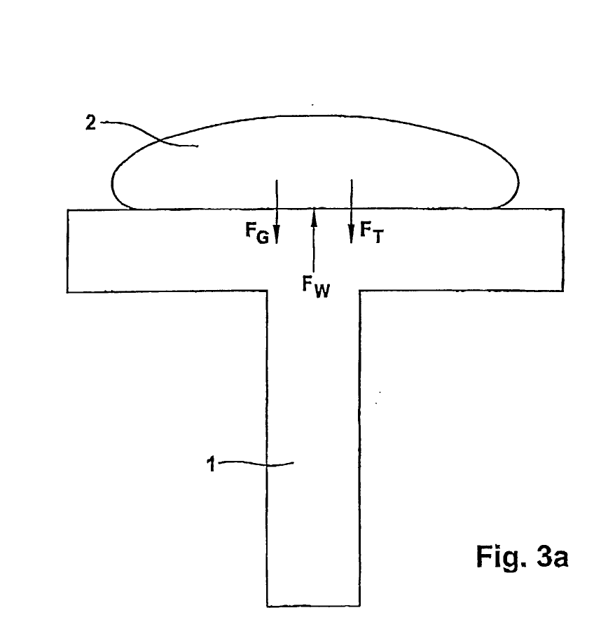

FIG. 3, the operation of lowering the lower tool;

FIG. 3a, the lower tool with the glass composition positioned on it along with the forces engaging the glass composition upon deceleration during the lowering operation of the lower tool shown in FIG. 3;

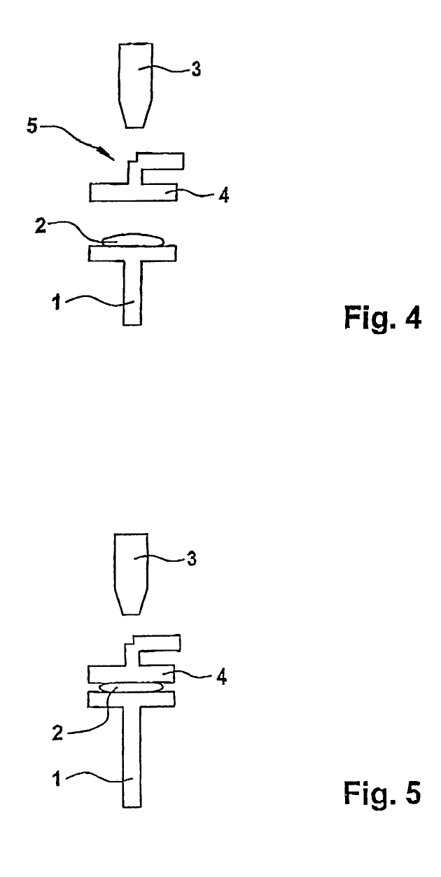

FIG. 4, the introduction of the upper tool; and

FIG. 5, the pressing of the glass gob.

FIG. 1 has already been described.

For the feeding operation shown in FIG. 2, the lower tool 1 is positioned just below the feeder outlet 3, so that the thin-bodied glass can be fed into the lower tool 1. The upper tool 4 at this time is in lateral parking position.

After the completion of the feeding operation, the lower tool, as shown in FIG. 3, is lowered vertically, together with the fed-in glass gob 2 located on it, down to a lower position of repose. FIG. 3a shows the lower tool 1 with the glass composition 2 positioned on it along with the forces engaging the glass composition 2 upon deceleration during the operation of lowering the lower tool 1 as shown in FIG. 3.

The forces shown, that is, the weight F_{G}, the inertial force F_{T}, and the force F_{W} exerted on the glass gob 2 by the lower tool 1, are the forces that act on the glass gob 2 in the context of the preforming. FIG. 3a illustrates the “compression” of the glass gob 2 between the force F_{W} exerted on the glass gob 2 by the lower tool 1 and its reaction force, which is the sum of F_{G} and F_{T}.

As a result of the lowering of the lower tool 1, with the glass gob 2 located on it, an interstice 5 is formed between the feeder outlet 3 and the lower tool 1.

FIG. 4 shows the introduction of the upper tool 4 into the interstice 5. The upper tool 4 is introduced into the interstice 5 in such a way that it comes to rest under the feeder outlet 3 and opposite the lower tool 1, so that pressing of the glass gob 2 located between the lower tool 1 and upper tool 4 can be done in a simple way by driving the upper tool 4 and the lower tool 1 toward one another. The upper tool 4 is fixed by a guide, not shown, in preparation for the actual pressing operation.

FIG. 5 shows the pressing of the glass gob 2 between the upper tool 4 and lower tool 1. In the present exemplary embodiments, the glass gob 2 is pressed into form by upward motion of the lower tool 1 in the direction of the fixed upper tool 4.

List of Reference Numerals

| | |
|---|---|
| 1 | Lower tool |
| 2 | Glass gob |
| 3 | Feeder outlet |
| 4 | Upper tool |
| 5 | Interstice |
| 10 | Round-table press |
| 11 | Press table |
| 12 | Lower tool |
| 13 | Feeder |
| 14 | Pressing station |
| 15 | Upper tool |

1. A method for producing thin glass articles, in particular substrates, in particular hard disk substrates, spherical and aspherical lens arrays, and micro- and macrostructured bodies of low-viscosity glass, in particular of glass with viscositiesⁿ<10 dpas, in which a thin-bodied glass composition (2) is fed into a lower tool (1), and the glass composition (2) is compressed by driving an upper tool (4), positioned opposite the lower tool (1), and the lower tool (1) together, characterized in that the surface roughness R_{Z} of the tools (1, 4) is between 5 and 15 μm, and between the method step of “feeding” and the method step of “compressing” is preformed by forces of acceleration, accelerations between 1 and 10 G (acceleration due to gravity) being realized.

2. The method of claim 1, characterized in that the glass gob (2) is preformed by vertically acting forces of acceleration.

3. The method of one of the foregoing claims, characterized in that the glass gob (2) is preformed by a downward-oriented, abruptly decelerated and acceleration-inducing motion of the lower tool (1).

4. The method of claim 3, characterized in that the maximum acceleration is achieved at the end of the lowering operation.

5. The method of one of claims 1 or 2, characterized in that the glass gob (2) is preformed by a upward-oriented, abruptly delayed and acceleration-inducing motion of the lower tool (1).

6. The method of claim 5, characterized in that the maximum acceleration is achieved at the beginning of the upward motion.

7. The method of one of the foregoing claims, characterized in that the glass melt is exposed essentially only to vertical forces between the method step of “feeding” and the method step of “compressing”.

8. The method of claim 7, characterized in that the lower tool (1), for the feeding operation, is positioned below the feeder outlet (3), and the thin-bodied glass is fed in; that after the termination of the feeding operation the lower tool (1) is lowered vertically, together with the fed-in glass gob (2), as far as a lower position of repose; and that the upper tool (4), located in a parking position during the feeding operation, is introduced into the interstice (5) formed between the feeder outlet (3) and the lower tool (1) by the lowering of the lower tool (1), the upper tool (4) being fixed for the pressing operation, and the glass gob (2) is pressed into form by the upward motion of the lower tool (1) in the direction of the thus-fixed upper tool (4).

9. The method of claim 7, characterized in that the lower tool (1), for the feeding operation, is positioned below the feeder outlet (3), and the thin-bodied glass is fed in; that after the termination of the feeding operation the lower tool (1) is lowered vertically, together with the fed-in glass gob (2), as far as a lower position of repose; and that the upper tool (4), located in a parking position during the feeding operation, is introduced into the interstice (5) formed between the feeder outlet (3) and the lower tool (1) by the lowering of the lower tool (1), wherein by downward motion of the upper tool in the direction of the lower tool (1) which is fixed for the pressing operation, the glass gob (2) is pressed into form.

10. The method of one of claims 8 or 9, characterized in that the upper tool (4) during the feeding operation is parked laterally and thus at the same height as the interstice (5) embodied between the feeder outlet (3) and the lower tool (1) by the lowering of the lower tool (1), and for the pressing operation the upper tool is positioned by a lateral, essentially horizontal inward shift or inward pivoting into the interstice (5) above the lower tool (1).

11. The use of a method of one of claims 1-10, characterized in that the method is used for producing electrically insulating carrier plates for electrical circuits and components, especially substrates for printed circuit boards, and for substrates on which electrical circuits are printed.

12. The use of a method of one of claims 1-10, characterized in that the method is used for producing hard disk substrates.
